(19) United States
(12) Patent Application Publication
(10) Pub. No.: US 2013/0239363 A1
(43) Pub. Date: Sep. 19, 2013

(54) Slow-Down Mechanism Placed in Furniture Hinge

(71) Applicant: Ertaç Çapur, Istanbul (TR)

(72) Inventor: Ertaç Çapur, Istanbul (TR)

(21) Appl. No.: 13/812,882

(22) PCT Filed: Oct. 21, 2011
(86) PCT No.: PCT/TR2011/000234

§ 371 Date: Jan. 29, 2013

(30) Foreign Application Priority Data
Oct. 14, 2010 (TR) 2010/08451
Apr. 21, 2011 (TR) 2011/03873

(51) Int. Cl. E05F 3/20

(52) U.S. Cl. CPC E05F 3/20
USPC 16/50

(57) ABSTRACT

The invention refers to a slow-down mechanism that prevents moving furniture units like covers, doors, etc. hitting the other side and making noise in cases of fast opening and closing actions towards fixed furniture units and thus enabling soft opening and closing actions for such moving furniture units, comprised of at least an arm (2), a bowl (3) and a internal and external knuckle element (6, 5) connecting the arm and bowl, and located inside the hinge. The invention refers especially to the capability to canceling the damper (18) belonging to the above-mentioned slow-down mechanism inside the hinge (1) and adjusting the damper's stroke depending on the weight of the moving furniture.

### TECHNICAL FIELD

This invention refers to a slow-down mechanism for moving furniture units like a door, wherein the mechanism is placed in a hinge which consists of minimum one arm and one cup and an internal and external articulating arm which associates the cup to the arm for slowing down the closure of moving components, for preventing noise, and preventing hitting of the moving component to the other side, to the fixed furniture unit when they are closed fast.

The invention is related especially to canceling the damper belonging to slow-down mechanism mentioned and adjusting the damper stroke depending on the weight of the moving furniture.

### PREVIOUS ART

Mechanisms which contain slowing down shock absorbers located at different points of both furniture and furniture hinge which ensure slowing down the closure of the moving door, thus prevent the damaging of the furniture and making a loud noise due to slamming on the other side while closing the furniture with one or multiple moving doors which open and close by means of hinges on fixed furniture cases are known in the previous art.

In this field; the mechanisms with a shock absorber installed on a fixed or moving furniture are known from the patent publications DE3729597, U.S. Pat. No. 6,408,483, and KR100731336B1, those with a shock absorber installed on a hinge arm are known from the patent publications EP1199433, EP1920128, WO2008020682, WO2009131348, the mechanisms which contain rotating shock absorbers installed on the side surface of a hinge cup are known from the patent publications WO2009/105794 and WO2008083417, the mechanisms which contain a rotating shock absorber installed under a hinge cup are known from the patent publications EP1344885, EP1969200, and WO2009115171, mechanisms which contain a shock absorber installed on a hinge cup are known from the patent publications WO2008136780, US20080209674, DE102007037480 and WO2005088052, the mechanisms which include a shock absorber installed under the hinge arm are known from the patent publications EP1555372, EP1375797, and WO2009021799.

Among the mentioned patents, the patent publication EP1555372 defines a shock absorber body fixed on the hinge arm in order to ensure slow closure of the moving doors on the fixed furniture, characterized in that the shock absorber's pivot is articulated by means of a power transferring component to the bottom articulation component among internal and external articulation components which bind the hinge's cup and hinge's arm on each other in a manner to allow their rotation.

Also the patent publication WO20090217799 mentions a similar application to that of the publication EP1555372.

The patent publication EP1375797 mentions a shock absorber body installed in the hinge arm in an adjustable manner, and the pivot of the shock absorber is articulated on a protrusion created on the internal articulation component by means of a pin.

The biggest drawback of the slowing down mechanisms in the mentioned hinge arm is fixing the shock absorber body in the hinge arm in a static manner.

Another drawback is the reduction of the lifetime of the shock absorber as the shock absorber's pivot is exposed to impacts especially in cases of fast closing and opening.

### OBJECTIVE AND FEATURES OF THE INVENTION

The purpose of the technique, keeping its known version in mind, is to develop a slow-down mechanism that will have moving units like covers, doors, etc. closed on fixed furniture units in the closing direction, mounted to the fixed furniture unit with at least one end while another is fixed to the moving furniture unit, located inside the hinge arm of the hinge made up of an arm and a bowl as well as at least one internal and external knuckle arm jointing the said arm and bowl to each other with pins, and preventing the damper's shaft suffering sudden shocks with the help of a damper having a body element mounted at least in a manner to move inside the hinge arm or an internal body taking place inside the hinge arm in cases where the moving cover is quickly opened and closed, thus extending the useful life of the damper; and, to have the capability, through the mechanism mentioned, to use the hinge also without damper by canceling the damper inside the hinge depending on the user's preference as well as the capability to make the stroke adjustment depending on the moving furniture's weight.

The invented furniture hinge, which is explained in more details with the following figures and reference numbers and which has been realized for achieving the mentioned objectives includes minimum one pulling arm which moves the shock absorber body while moving from open position to closed position and enables resting the shock absorber pivot onto the supporting component which is articulated on the inner articulating arm of the shock absorber pivot and operates the shock absorber, one end of which is connected to the shock absorber body connected to the pin in a channel and/or pivot along the hinge arm and/or internal body, and the other end of which is articulated on the protrusion on the inner articulating arm and/or on a pin which would have the same function, which contains minimum one hole which enables moving the pin on the shock absorber body, and minimum one spring which is attached on the shock absorber's pivot and which moves the shock absorber body to the initial position, in other words which rewinds the shock absorber while moving the hinge from the open position to close position.

One feature of the invention is that; as the pulling arm in the mentioned mechanism acts according to the movement of the internal and external articulating arm, the shock absorber body moves independent from the pulling arm when it is taken from closed position to open position, so involves a longitudinal pivot which is installed on the pin over the shock absorber body and which enables moving the shock absorber with spring force.

One other feature of the invention is that the shock absorber pivot may be attached to the supporting component either in a fixed manner or it can be positioned on an interim component with a pivot in a manner that it can act freely.

One other feature of the invention is that the shock absorber body may be positioned in the longitudinal pivot along the side surface of the internal body of the hinge arm, or it may also be positioned in the mentioned hole by means of protruding pins created on the shock absorber body.

The structural and characteristic features of the invention and its all advantages will be understood more clearly by means of the following shapes and the detailed description given with references to the figures, and therefore the assessment must consider these figures and the detailed description.

### DESCRIPTION OF FIGURES

FIG. 1—Slowing down mechanism and top perspective disassembly view of the hinge.

FIG. 2—Top perspective assembly and cross sectional view of the hinge.

FIG. 3—Side cross sectional view of the hinge in open position.

FIG. (4-7)—Top perspective partial cross sectional view of the hinge in opening position until the moment of closing.

FIG. 8—Side cross sectional view of the alternative embodiment.

FIG. 9—Top perspective view of the adjusting mechanism connected to the damper.

FIG. 10—Top perspective disassembly view of the adjusting mechanism.

FIG. 10a—Bottom perspective disassembly view of the adjusting mechanism.

FIG. 11—Sectional side view related to inactivating the damper inside the hinge in its open position.

FIG. 12—Sectional side view related to the stroke adjustments of the damper inside the hinge in its open position.

FIG. 13—Sectional side view belonging to the hinge and the damper in its closed position.

### REFERENCE NUMBERS

1—Hinge

2—Arm

3—Cup

4—Assembly sole plate

4.1—Channel

5—External articulating arm

6—Internal articulating arm

6.1—Protrusion

7—Pin

8—Spring

9—Pin

10—Pin

11—Pin

12—Internal body

12.1—Longitudinal channel and/or hole

13—Height adjustment screw

14—Eccentric back & forth adjustment screw

14.1—Perforated surface

15—Flexible holder component

16—Spring

17—Pin

18—Shock absorber

18.1—Moving shock absorber body

18.2—Pivot

18.3—Protrusion

19—Supporting component

20—Interim component

20.1—Channel

21—Pulling arm

21.1—Hole

22—Pin

23—Spring

24—Latch

24.1—Hook

25—Adjusting mechanism

25.1—Adjusting screw

25.2—Helical tooth

25.3—Body

25.4—Hole

25.5—Holder

25.6—Moving stopper body

25.7—Successive protrusions

### DESCRIPTION OF THE INVENTION IN DETAIL

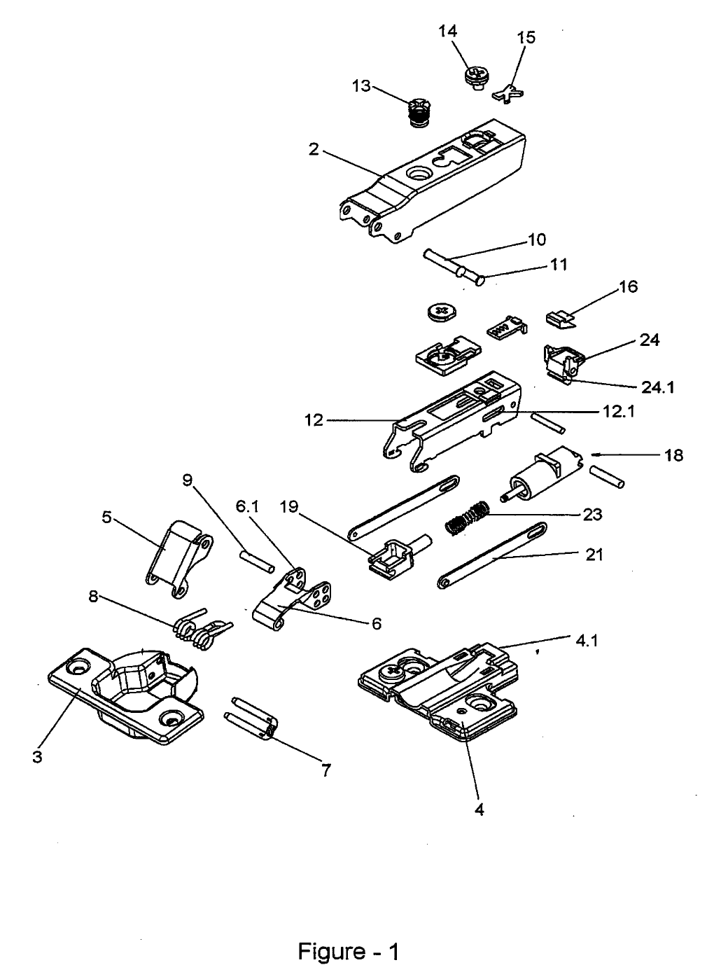

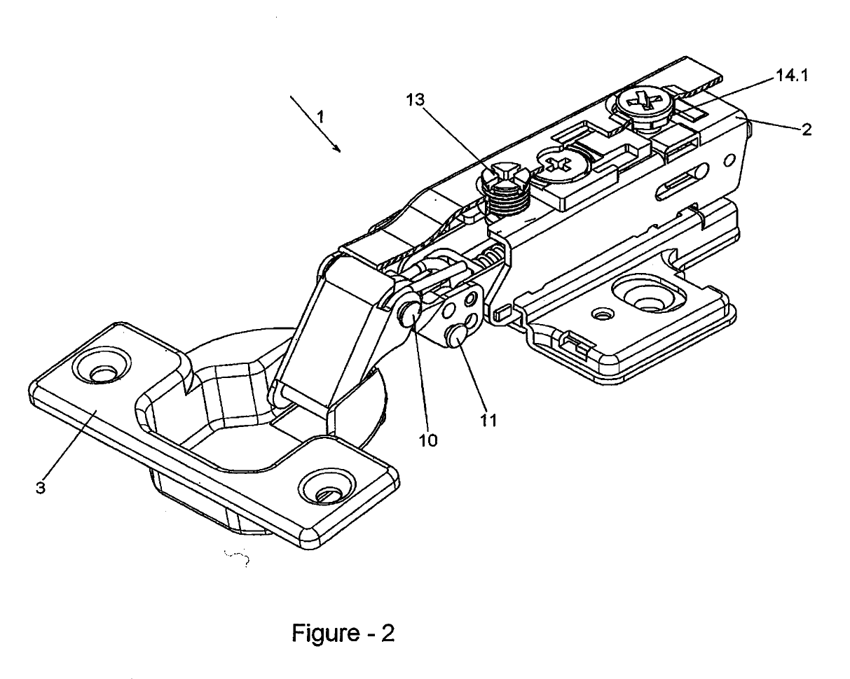

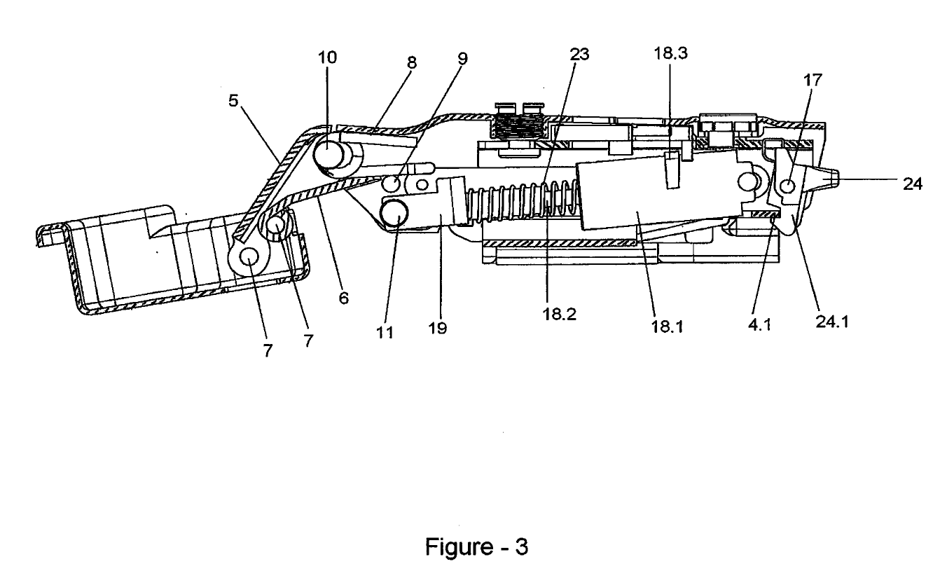

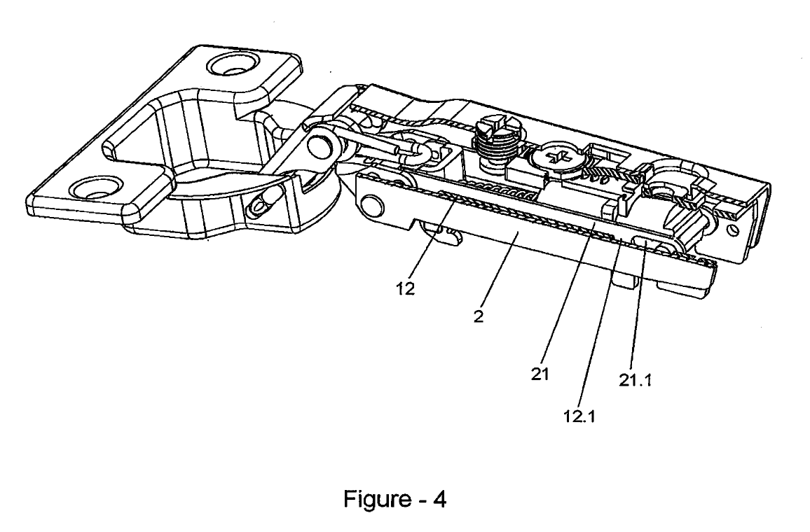

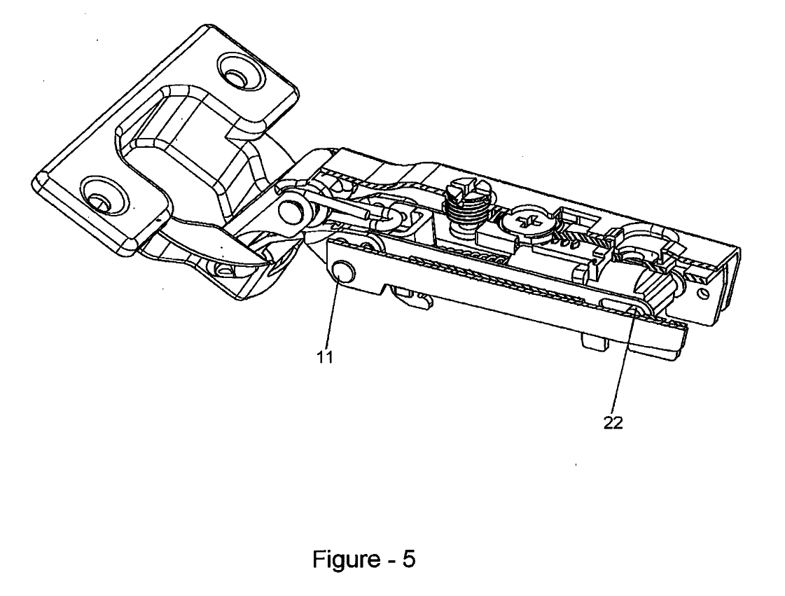

FIG. 1 represents top perspective disassembly view of all components which belong to the slowing down mechanism and the hinge. According to the figure, the hinge (1) consists of minimum one cup (3) for installation into the socket on minimum one of the furniture panels, an arm (2) for installation on the other furniture panel by means of an installation sole plate (4), internal (6) and external articulating arms (5) which connect the hinge arm on the hinge cup in a rotating manner through the holes on it by means of pins (7, 10, 11), a pre-loaded spring (8) which is attached to the pin of the external articulating arm and one end of which applies pressure on the pin (9) over the internal articulating arm and prevents undesired opening of the hinge arm when it is in closed position, and an internal body (12) component which provides connection to the hinge arm and the installation soleplate in the hinge arm.

Also according to the figure, the mentioned hinge preferably includes a height adjustment screw (14) for height adjustment of the hinge arm on the internal body, an eccentric adjustment screw (14) for back and forth adjustment of the hinge arm on the internal body (12), a flexible holder component (15) which prevents slipping of the setting screw by bouncing towards perforated surfaces (14.1) on the adjustment screw in order to prevent the deformation of back & forth adjustment, and a hatch component (24) which is articulated in the inner body by means of a spring (16) and a pin (17) and which bounces and interlocks with the installation sole plate (4) through the channel (4.1) on the installation base plate by means of a hook (24.1) on it.

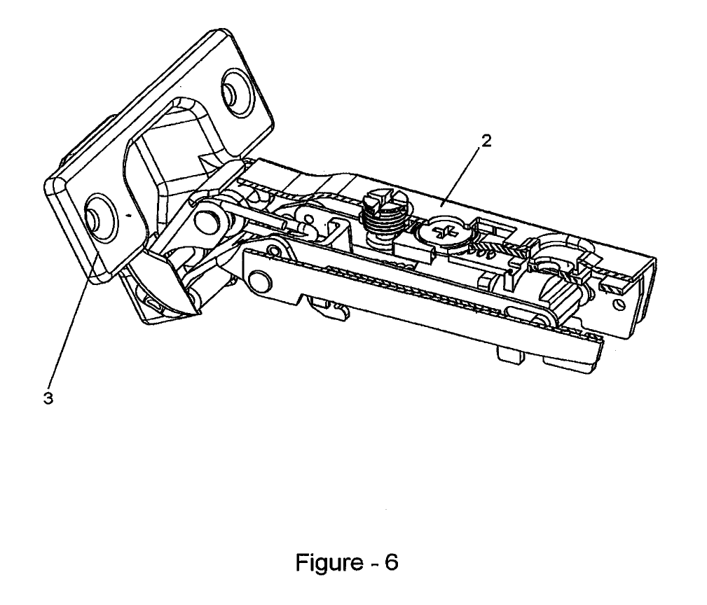

According to the figures, the mentioned hinge (1) which is used for opening and closing moving furniture items such as a cover or a door on a fixed furniture includes a gas, air, oil or spring shock absorber (18) in it for slowing down the closing of the moving door, and especially in order to prevent the shock absorber pivot's exposure to impacts in cases of fast opening and closing and to increase the lifetime of the shock absorber, the body of the mentioned shock absorber is positioned in a moveable manner in the hinge arm (2) and/or inner body (12), while the shock absorber pivot (18.2) is attached to the supporting component (19) which is articulated to the hinge arm (2) by means of a pin (11) over the internal articulating arm (6). The reason for connecting the shock absorber pivot to the supporting component is to prevent the relocation of the supporting component due to the articulation movement, and to ensure that the pivot (18.2) presses properly on the supporting component when the hinge is opened and closed. In one alternative embodiment of the invention (FIG. 8), the shock absorber pivot (18.2) is positioned in a manner that it moves in the channel (20.1) of an interim component (20) which is overspread on the supporting component.

Also according to the figures, the slowing down mechanism positioned in the furniture hinge includes minimum one spring which moves the shock absorber body while the hinge moves from open position to closed position and enables resting the shock absorber pivot onto the supporting component (19) thus enabling the operation of the shock absorber (18), one end of which is articulated to the hinge arm (2) and/or to the shock absorber body (18.1) which is attached freely with a pin (22) in the longitudinal channel and/or hole (12.1) on the inner body (12), and the other end of which is articulated to the protrusion (6.1) on the inner articulating arm (6) and/or to the pin which would have the same function, minimum one pulling arm (21) with minimum one hole (21.1) that enables the movement of the pin on the shock absorber body, which is attached to the shock absorber body and which moves back the shock absorber body to its initial state, or in other words rewinds the shock absorber pivot (18.2) as the hinge moves from the open position to close position. The components named as the fixed furniture, moving furniture or the furniture panel are not illustrated on the figures as they are not required).

FIGS. 4 to 7 provide illustrations of the shock absorber's movement from open position to closed position. According to the figure, when the hinge arm is closed in the cup direction, due to the rotating axis of the inner and outer articulation, the pulling arm (21) pulls the and moves the moving shock absorber body (18.1) in the longitudinal channel and/or hole (12.1) on the hinge arm or inner body. As the hinge turns from closed position to open position, the spring which is pressed between the supporting component surface (19) and the shock absorber pivot (18.2) returns the moving shock absorber body (18.1) to its initial position by the help of the pivot (21.1) which occurs on the pulling arm (21). Here, the pivot on the pulling arm prevents damaging the shock absorber pivot because of impacts due to the moving cover, in other words the hinge arm or the hinge cup in case of fast opening.

As the pulling arm (21) in the mentioned mechanism acts according to the movement of the internal and external articulating arm (6, 5), the shock absorber body moves independent from the pulling arm when it is taken from closed position to open position, so involves a longitudinal pivot (21.1) which is installed on the pin over the shock absorber body and which enables moving the shock absorber with spring force.

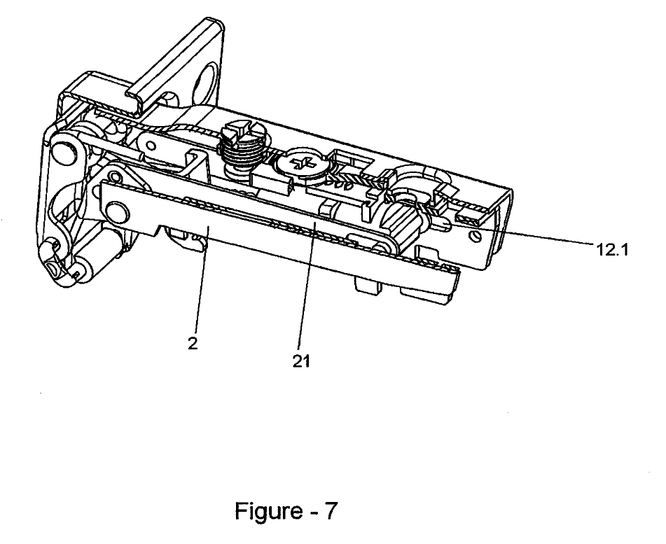

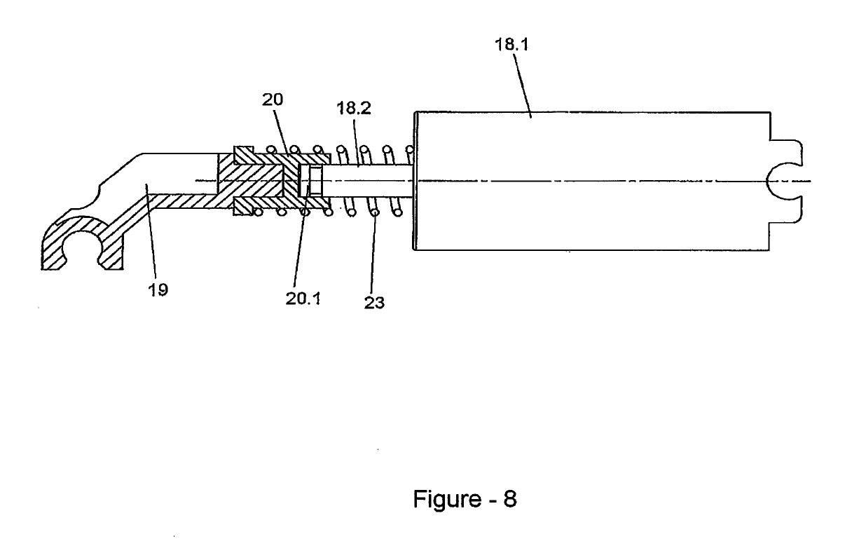

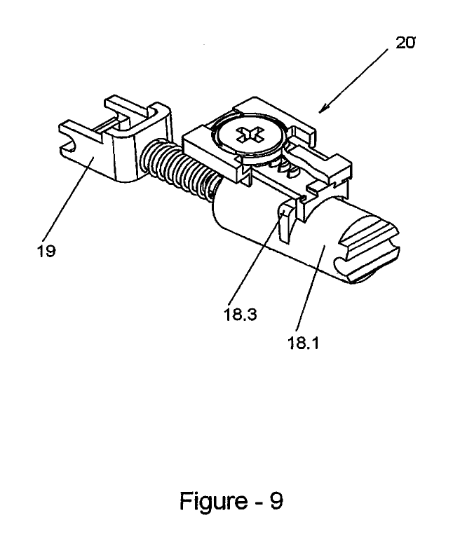

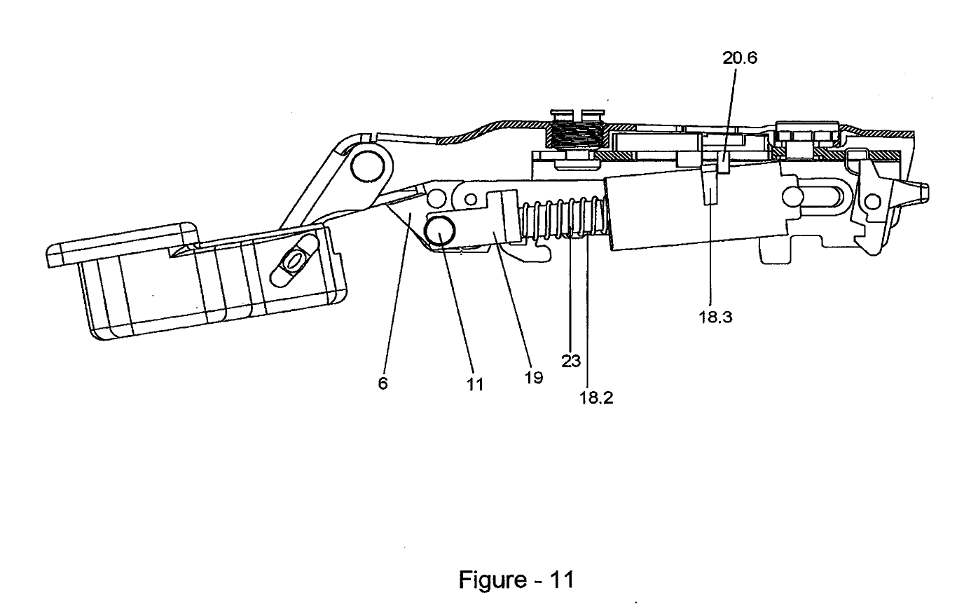

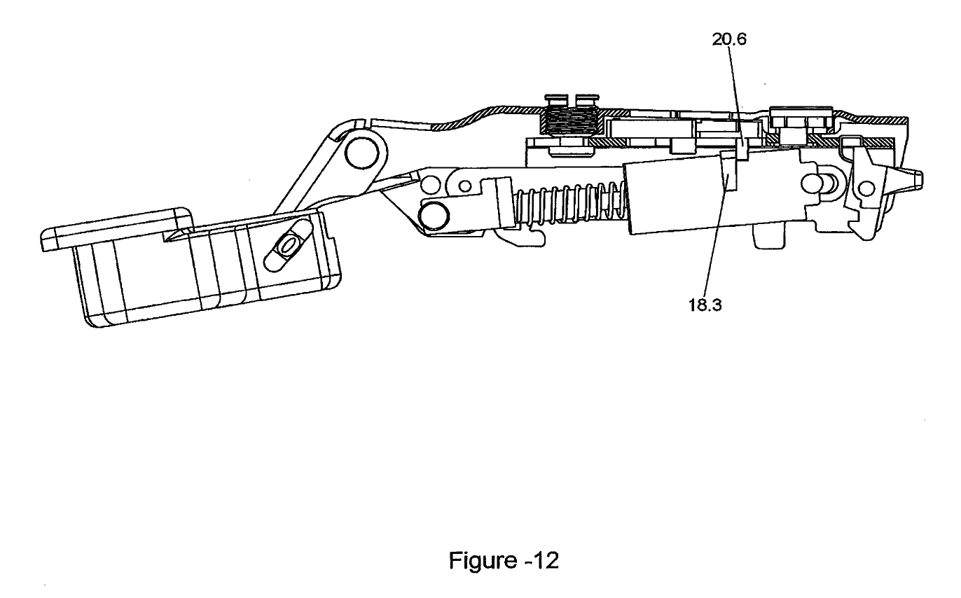

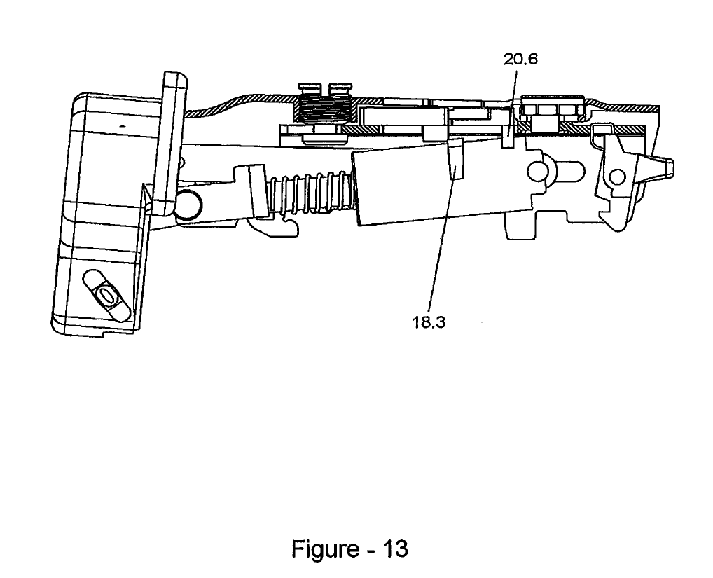

FIG. 9-13 represents the view related to the use of the hinge also without damper by cancelling it inside the hinge depending on the user's preference as well as the view showing the possibility to adjust the damper's stroke depending on the weight of the moving furniture.

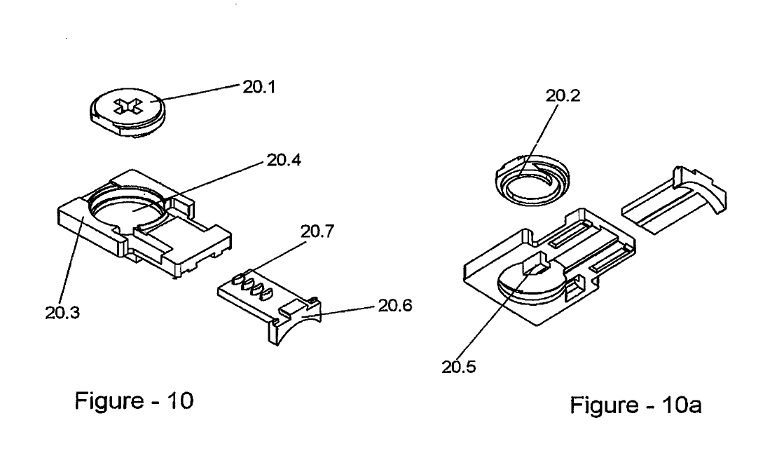

FIGS. 10 and 10a represent the views belonging to the adjusting mechanism (25) making the stroke adjustments if the damper (18) or inactivating the damper inside the hinge. According to the figure, the adjusting mechanism (25) contains a body (25.3) fixed under the hinge arm (2), an adjusting screw (25.1) located in the hole (25.4) on the body and having a helical tooth (25.2) under it, and a moving stopper body (25.6) which is held by the stopper (25.5) under the said body and incorporating successive protrusions (25.7) which may be moved by the adjusting screw under the body.

According to the above-mentioned figures, the helical tooth (25.2) of the adjusting screw (25.1) which is located in the hole (25.4) on the body (25.3) fixed under the hinge arm (2) is rotated and the helical tooth of the adjusting screw (25.2) makes the moving stopper body (25.6) move back and forth on successive protrusions (25.7), then holding the damper at its protrusion (18.3) and preventing damper's shaft (18.2), connected to the support element (19) which is further connected to the internal knuckle arm (6) with a pin (11), stop and set under the spring's (23) effect and/or adjust it and thus making damper (18) inactivated and/or making stroke adjustment.

1.-17. (canceled)

18. A hinge comprising: at least one cup for installation into a socket on a first furniture panel, a hinge arm for installation on a second furniture panel using an installation sole plate, internal and external articulating arms which connect the hinge arm to the hinge cup in a rotating manner using one or more pins which mate with one or more holes of the hinge arm, a pre-loaded spring which mates with a first pin and one or more holes on the external articulating arm, a second pin which mates with one or more holes on the internal articulating arm which prevents undesired opening of the hinge arm when it is in closed position, and an internal body component which is contained within the hinge arm and provides connection to the hinge arm and the installation soleplate, wherein the internal body houses a gas, air, oil and/or spring shock absorber comprising a shock absorber body and shock absorber pivot for slowing down the closing of the first or second furniture panel, at least one pulling arm which moves the shock absorber body and ensures mating of the shock absorber pivot to a supporting component such that one end of the pulling arm is connected to the hinge arm or to the longitudinal channel on the internal body or to the shock absorber body, and the other end of the pulling arm mates with one or more holes on the inner articulating arm wherein the pulling arm includes a longitudinal cut out in order to prevent damaging the shock absorber pivot from impacts upon a fast opening furniture panel wherein the shock absorber moves independently from the pulling arm.

19. The hinge of claim 18, further comprising an intermediate member containing a channel, the intermediate member being placed on the supporting component and enabling the movement of the shock absorber pivot without being fixed on the supporting component.

20. The hinge of claim 19, wherein the spring is placed on the shock absorber pivot and independently moves the shock absorber body from closed position to open position by acting free from the pulling arm by means of the longitudinal cut out on the pulling arm.

21. The hinge of claim 18, further comprising an adjusting mechanism which adjusts the tension of the spring thus enabling dampering of the shock absorber.

22. The hinge of claim 21, wherein the shock absorber body contains at least one protrusion designed to mate with the adjusting mechanism.

23. The hinge of claim 22, wherein the adjusting mechanism comprises a body containing a hole adapted to fit an adjusting screw, the adjusting mechanism being fixed under the hinge arm.

24. The hinge of claim 23, wherein the adjusting screw is threaded and adapted to be rotated within the hole on the adjusting mechanism body.

25. The hinge of claim 24, further comprising a moving stopper body having successive protrusions such that while the adjusting screw is rotated within the hole inside the body, the moving stopper body slides such that one or more protrusions of the moving stopper body mates with one or more protrusions on the shock absorber body resulting in adjustment of tension of the spring.

26. A hinge comprising:
a hinge cup for installation into at least one socket on a first furniture panel,
a hinge arm for installation on a second furniture panel,
an internal articulating arm and external articulating arm which connect the hinge arm to the hinge cup in a rotating manner,
an internal body component either completely or partially contained within the hinge arm having an inner channel which houses a shock absorber for slowing down the closing of the first or second furniture panel, the shock absorber being comprised of a shock absorber body and shock absorber pivot,
wherein the internal body component contains at least one longitudinal cut out adapted to slidably mate with a pin in connection with the shock absorber body such that the shock absorber body may be moved along the length of the longitudinal cut out during the closing or opening of the first or second furniture panel.

27. The hinge of claim 26, further comprising a pulling arm lying adjacent to the internal body component having a longitudinal cut out which is configured to slidably mate with the pin in connection with the shock absorber body such that the shock absorber body may be moved along the length of the longitudinal cut out of the pulling arm during the closing or opening of the first or second furniture panel.

28. The hinge of claim 26, wherein the shock absorber comprises a spring threaded on the shock absorber pivot and lying between the shock absorber body and a supporting component such that the spring contracts or expands against the supporting component and shock absorber body during the closing or opening of the first or second furniture panel.

29. The hinge of claim 28, further comprising an intermediate member placed in connection with the supporting component which enables the movement of the shock absorber pivot without the shock absorber being fixed on the supporting component.

30. The hinge of claim 26, further comprising an adjusting mechanism which adjusts the tension of the spring thus enabling dampering of the shock absorber.

31. The hinge of claim 30, wherein the shock absorber body contains at least one protrusion in connection with the adjusting mechanism on the shock absorber body.

32. The hinge of claim 31, wherein the adjusting mechanism comprises a body containing a hole adapted to fit an adjusting screw, the adjusting mechanism being fixed under the hinge arm.

33. The hinge of claim 32, wherein the adjusting screw is threaded and adapted to be rotated within the hole on the adjusting mechanism body.

34. The hinge of claim 33, wherein rotation of the adjusting screw results in the adjustment of tension in the shock absorber spring.

35. The hinge of claim 34, further comprising a moving stopper body slidably connected to the underside of the adjusting mechanism body having successive protrusions, at least one of which is designed to lock in between two protrusions on the shock absorber body.

36. The hinge of claim 35, wherein as the adjusting screw is rotated, the moving stopper body slides such that one or more protrusions of the moving stopper body mate with one or more protrusions on the shock absorber body.

37. The hinge of claim 27, wherein when the hinge is moved from an open position to a closed position, the shock absorber body is moved from one end of the longitudinal cut out of the pulling arm to the opposite end of the longitudinal cut out of the pulling arm.
